(19) United States
(12) Patent Application Publication
(10) Pub. No.: US 2009/0089673 A1
(43) Pub. Date: Apr. 2, 2009

(54) System and Method for Persisting Hover Help

(76) Inventors: Lloyd W. Allen, JR., Cary, NC (US); Jana H. Jenkins, Releigh, NC (US); Steven M. Miller, Cary, NC (US)

Correspondence Address: HAMILTON & TERRILE, LLP;IBM RSW, P.O. BOX 203518, AUSTIN, TX, 78720, US

(21) Appl. No.: 11/862,229

(22) Filed: Sep. 27, 2007

(51) Int. Cl. G06F 3/01

(52) U.S. Cl. 715/708; 715/705

(57) ABSTRACT

A method, system and computer-usable medium are disclosed for providing a persistent display of hover assistance elements in a user interface. A user interface (UI) containing hover assistance elements is selected and a persistent hover assistance manager is used to simultaneously display all hover assistance elements in a viewable area of the UI. The hover assistance elements, with their respective hover assistance values, are then persistently displayed proximate to their corresponding UI elements. Hover assistance elements are selectively removed from persistent display and then selectively returned to persistent display.

### BACKGROUND OF THE INVENTION

1. Field of the Invention

Embodiments of the disclosure relate in general to the field of computers and similar technologies, and in particular to software utilized in this field. Still more particularly, it relates to displaying hover assistance in a user interface.

2. Description of the Related Art

Ongoing improvements in the power and capabilities of computing platforms have been accompanied by the development of progressively more sophisticated software applications. However, this sophistication typically comes at the cost of increased complexity for the user, despite the extensive adoption of user-friendly interfaces such as a graphical user interface (GUI). The advent of GUIs has resulted in a widespread expectation that an intuitive and aesthetically pleasing interface would facilitate users being able to interact more effectively with software applications. As a result, GUIs have contributed to the fact that many users do not read software application manuals before attempting to use a software application. Instead, users typically rely on the intuitive nature of the application and the corresponding GUI itself.

The intuitiveness of a software application is often improved by hover assistance. Hover assistance comprises displaying help (or other) information when a user places, or hovers, a mouse cursor over a selected GUI element for a predetermined amount of time. When the mouse cursor is removed from the selected GUI element, the help information is removed from display. Hover assistance has become pervasive in many existing operating systems. It has also become common in currently developed software applications for text fields, toolbar icons, taskbar buttons, and displayed images to have associated hover assistance capabilities.

However, current approaches to the implementation of hover assistance require that hover assistance elements be opened iteratively and independently. The user is unable to open all hover assistance elements within a user interface at the same time. As a result, the user typically does not know in advance which GUI element has an associated hover assistance element, and if it does, what it contains. Furthermore, it is difficult for a user to know the level of assistance information detail a given hover assistance contains. Similar challenges are presented to software application developers when testing hover assistance elements, as it is difficult to not only visualize the relative placement of each window within the GUI, but also to ensure each window is populated with assistance information. It is likewise difficult for documentation writers and editors to check for the accuracy, consistency, and completeness of the assistance information within each of the hover assistance elements. Accordingly, the inability to simultaneously open all hover assistance elements within a GUI can lead to developer and user frustration, inefficiency, and increased errors.

### BRIEF SUMMARY OF THE INVENTION

The present invention includes, but is not limited to, a method, system and computer-usable medium for providing a persistent display of hover assistance elements in a user interface. In various embodiments of the invention, a user interface (UI) containing hover assistance elements is selected and a persistent hover assistance manager is used to simultaneously display all hover assistance elements in a viewable area of the UI. The hover assistance elements, with their respective hover assistance values, are then persistently displayed proximate to their corresponding UI elements. In one embodiment, hover assistance elements are selectively removed from persistent display and then selectively returned to persistent display. In another embodiment, predetermined visual attributes are applied to each of the hover assistance elements and their corresponding UI element to indicate their respective association. The above, as well as additional purposes, features, and advantages of the present invention will become apparent in the following detailed written description.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 depicts an exemplary client computer in which the present invention may be implemented;

FIG. 2 is a flowchart showing the operation of a persistent hover assistance manager as used in an embodiment of the invention;

FIGS. 3a and 3b show a simplified user interface (UI) as used in the operation of a persistent hover assistance manager;

FIG. 4 shows a simplified UI of a persistent hover assistance manager as used to indicate links between UI elements and their corresponding hover assistance elements; and

FIG. 5 shows a simplified UI of a persistent hover assistance manager as used with visual attributes to indicate associations between UI elements and their corresponding hover assistance elements.

### DETAILED DESCRIPTION

A method, system and computer-usable medium are disclosed for providing a persistent display of hover assistance elements in a user interface. As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therein, either in baseband or as part of a carrier wave. The computer usable program code may be transmitted using any appropriate medium, including but not limited to the Internet, wireline, optical fiber cable, radio frequency (RF), etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

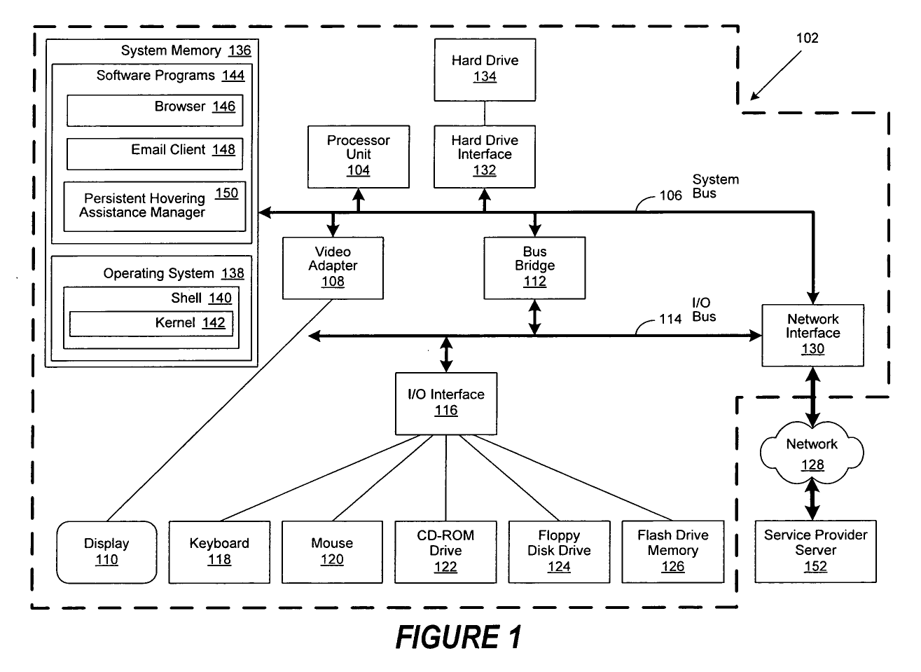

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 152 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 152.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes the client computer's 102 operating system (OS) 138 and software programs 144.

OS 138 includes a shell 140 for providing transparent user access to resources such as software programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and software programs 144, including memory management, process and task management, disk management, and mouse and keyboard management.

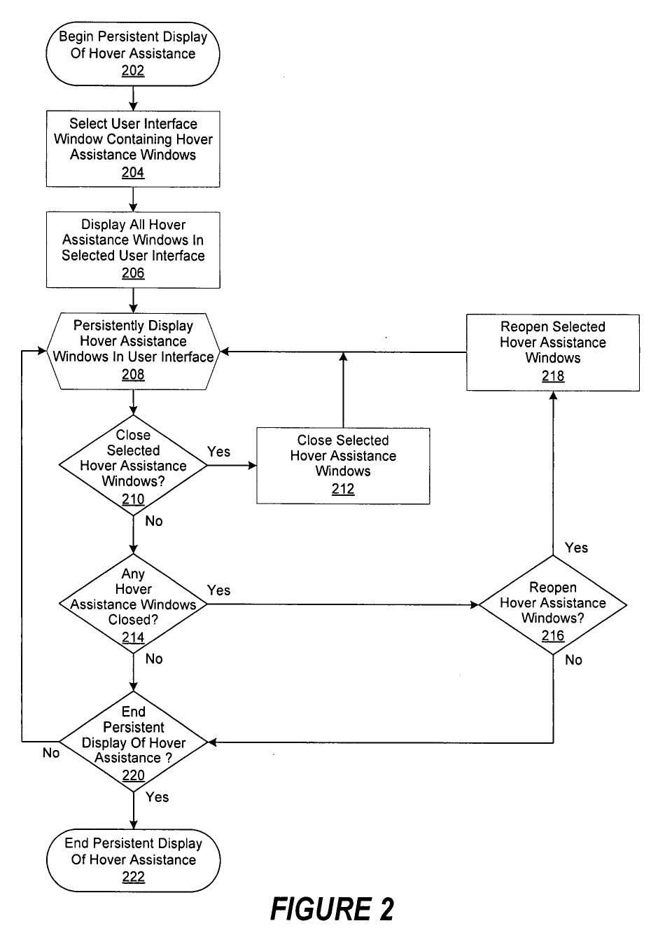

Software programs 144 may include a browser 146 and email client 148. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 152. Software programs 144 also include a persistent hover assistance manager persistent hover assistance manager 150. The persistent hover assistance manager 150 includes code for implementing the processes described in FIGS. 2 through 5 described hereinbelow. In one embodiment, client computer 102 is able to download the persistent hover assistance manager 150 from a service provider server 152.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

FIG. 2 is a flowchart showing the operation of a persistent hover assistance manager as used in an embodiment of the invention. In this embodiment, the persistent display of hover assistance is begun in step 202, followed by the selection in step 204 of a user interface (UI) window containing hover assistance elements. Once the UI window is selected, a persistent hover assistance manager is used to display all hover assistance elements in the UI window. The hover assistance elements are then persistently displayed in step 208. A determination is then made in step 210 whether to selectively close individual hover assistance elements. If it is determined in step 210 to selectively close individual hover assistance elements, then they are closed in step 212. For example, a cursor can be placed over the selected hover assistance element and a user gesture, such as a right-mouse-click, can invoke a menu containing a command to close the hover assistance element. Once the selected hover assistance elements are closed, the process is continued, beginning with step 208. If it is determined in step 210 to not selectively close individual hover assistance elements, then a determination is made in step 214 whether any persistently-displayed hover assistance elements have been closed. If they have, then a determination is made in step 216 whether to reopen the hover assistance elements. If it is decided to reopen the hover assistance elements, then they are reopened in step 218 and the process is continued, beginning with step 208. If it is determined in step 214 that no hover assistance elements have been closed, or if it is decided in step 216 to not reopen the hover assistance elements, then a determination is made in step 220 whether to end the persistent display of hover assistance. If it is decided to continue the persistent display of hover assistance, then the process continues, beginning with step 208. Otherwise, the persistent display of hover assistance is ended in step 222.

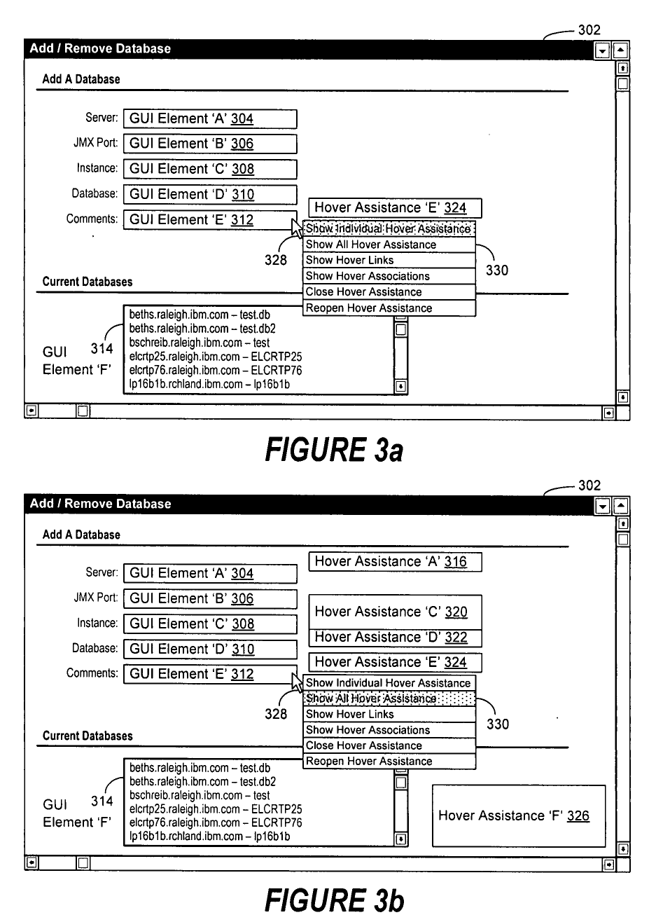

FIGS. 3a and 3b show a simplified user interface (UI) 302 as used in the operation of a persistent hover assistance manager. In this embodiment, UI 302 comprises graphical user interface (GUI) elements ‘A’ 304, ‘B’ 306, ‘C’ 308, ‘D’ 310, ‘E’ 312, and ‘F’ 314. As shown in FIG. 3a, individual hover assistance elements are displayed by placing cursor 328 over the GUI element ‘E’ 312. A user gesture, such as a right-mouse-click results in the display of the command menu 330 for a persistent hover assistance manager. Selecting the “Show Individual Hover Assistance” selection of command menu 330 results in the display of hover assistance element ‘E’ 324 proximate to GUI element ‘E’ 312.

As shown in FIG. 3b, all hover assistance elements 316, 320, 322, 324, 326, present in UI 302 are displayed by first placing cursor 328 over the GUI element ‘E’ 312. A user gesture, such as a right-mouse-click then results in the display of the command menu 330 for a persistent hover assistance manager. Selecting the “Show All Hover Assistance” selection of command menu 330 results in the display of hover assistance elements ‘A’ 316, ‘C’ 320, ‘D’ 322, ‘E’ 324, and ‘F’ 326, which are respectively displayed proximate to GUI elements ‘A’ 304, ‘C’ 308, ‘D’ 310, ‘E’ 312, and ‘F’ 314. Additionally, selecting the “Group Hover Assistance” selection of command menu 330 results in the display of a subset of all hover assistance elements that are identified for inclusion, creating a similar effect of showing all hover helps, but with a targeted subset of hover helps, logically grouped according to whatever schema desires the grouping. In either case, in one embodiment, individual hover assistance elements can be removed from persistent display, and then redisplayed, by choosing other command options in command menu 330. In this and other embodiments, hover assistance elements ‘A’ 316, ‘C’ 320, ‘D’ 322, ‘E’ 324, and ‘F’ 326 comprise hover assistance values that are likewise persistently displayed. It will be apparent to those of skill in the art that the persistent display of hover assistant values facilitates the identification of vacant or incorrect values contained by individual hover assistance elements. The determination of the visual positioning of hover assistance elements respective to each other is similarly facilitated. For example, the persistent display of hover assistance elements ‘A’ 316, ‘C’ 320, ‘D’ 322, ‘E’ 324, and ‘F’ 326 in UI 302 shows that hover assistance element ‘C’ 320 visually intrudes upon hover assistance element ‘D’ 322.

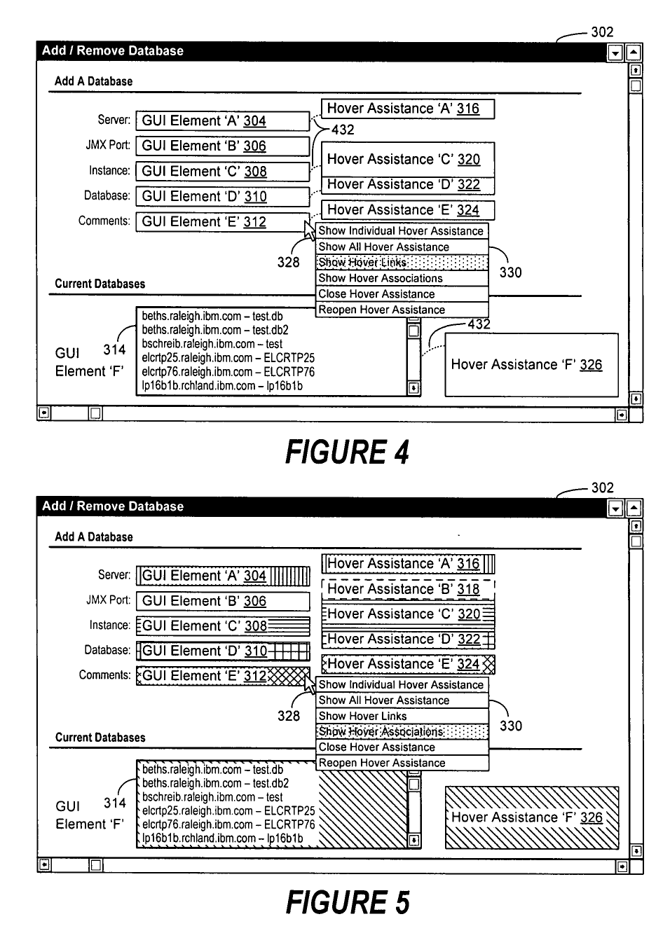

FIG. 4 shows a simplified user interface (UI) of a persistent hover assistance manager as used to indicate links between GUI elements and their corresponding hover assistance elements In this embodiment, UI 302 comprises graphical user interface (GUI) elements ‘A’ 304, ‘B’ 306, ‘C’ 308, ‘D’ 310, ‘E’ 312, and ‘F’ 314. All hover assistance elements 316, 320, 322, 324, 326, present in UI 302, along with links 432 to their respective GUI elements 304, 306, 308, 310, 312, are displayed by first placing cursor 328 over the GUI element ‘E’ 312. A user gesture, such as a right-mouse-click then results in the display of the command menu 330 for a persistent hover assistance manager. Selecting the “Show Hover Links” selection of command menu 330 results in the display of hover assistance elements ‘A’ 316, ‘C’ 320, ‘D’ 322, ‘E’ 324, and ‘F’ 326, which are displayed with their respective links 432 to GUI elements ‘A’ 304, ‘C’ 308, ‘D’ 310, ‘E’ 312, and ‘F’ 314.

In one embodiment, individual hover assistance elements and their respective links 432 can be removed from persistent display, and then redisplayed, by choosing other command options in command menu 330. It will be appreciated that the persistent display of hover assistance links to their respective GUI elements facilitates the identification of GUI elements that do not have an associated hover assistance element. For example, the persistent display of hover assistance elements ‘A’ 316, ‘C’ 320, ‘D’ 322, ‘E’ 324, ‘F’ 326, and their respective links 432 in UI 302, shows that GUI element ‘B’ 306 has no associated hover assistance element.

FIG. 5 shows a simplified user interface (UI) of a persistent hover assistance manager as used with visual attributes to indicate associations between UI elements and their corresponding hover assistance elements. In this embodiment, UI 302 comprises graphical user interface (GUI) elements ‘A’ 304, ‘B’ 306, ‘C’ 308, ‘D’ 310, ‘E’ 312, and ‘F’ 314. All hover assistance elements 316, 320, 322, 324, 326, present in UI 302 are displayed by first placing cursor 328 over the GUI element ‘E’ 312. A user gesture, such as a right-mouse-click then results in the display of the command menu 330 for a persistent hover assistance manager. Selecting the “Show Hover Associations” selection of command menu 330 results in the persistent display of hover assistance elements ‘A’ 316, ‘C’ 320, ‘D’ 322, ‘E’ 324, and ‘F’ 326.

In one embodiment, predetermined visual attributes, such as color or text attributes, are applied to the text or backgrounds of each of the GUI elements ‘A’ 304, ‘C’ 308, ‘D’ 310, ‘E’ 312, ‘F’ 314, and their corresponding hover assistance elements ‘A’ 316, ‘C’ 320, ‘D’ 322, ‘E’ 324, ‘F’ 326. It will be apparent that the persistent display of hover assistance associations to their respective GUI elements facilitates the identification of GUI elements that do not have an associated hover assistance element. For example, the persistent display of hover assistance elements ‘A’ 316, ‘C’ 320, ‘D’ 322, ‘E’ 324, ‘F’ 326, and their respective links 432 in UI 302, shows that GUI element ‘B’ 306 is lacking a corresponding hover assistance element ‘B’ 318. Since hover assistance element ‘B’ 318 is not present, no visual attribute has been applied to GUI element ‘B’ 306, thereby visually emphasizing the absence of hover assistance element ‘B’ 318. In another embodiment, individual hover assistance elements and their respective visual attributes can be removed from persistent display, and then redisplayed, by choosing other command options in command menu 330.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of skill in the art without departing from the scope and spirit of the invention. The embodiment was chosen and described in order to best explain the principles of the invention and the practical application, and to enable others of skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A computer-implementable method for displaying hover assistance in a user interface, comprising:
enabling selection of a user interface (UI) window, the UI window comprising a UI element and an associated hover assistance element;
displaying the hover assistance element with the UI element within a viewable area of the UI window; and
persisting display of the hover assistance element.

2. The method of claim 1, wherein the hover assistance element further comprises a hover assistance value, the hover assistance value being displayed when the hover assistance element is persisted.

3. The method of claim 1, wherein:
the UI window comprises a plurality of UI elements and a plurality of associated hover assistance elements; and further comprising
displaying the plurality of hover assistance elements simultaneously within a viewable area of the UI window; and
persisting the display of the plurality of hover assistance elements.

4. The method of claim 3, wherein predetermined visual attributes are applied to each of the plurality of hover assistance elements and each associated UI element, the predetermined visual attributes indicating an association between each of the plurality of hover assistance elements and an associated UI element.

5. The method of claim 3, wherein visual attributes are applied to each of the plurality of UI elements that do not have an associated hover assistance element.

6. The method of claim 3, wherein each of the plurality of hover assistance elements are operable to be selectively removed from persistent display and then selectively returned to persistent display, and, displaying a remaining plurality of hover assistance elements after a hover assistance element is removed.

7. A system comprising:
a processor;
a data bus coupled to the processor; and
a computer-usable medium embodying computer program code, the computer-usable medium being coupled to the data bus, the computer program code displaying hover assistance in a user interface and comprising instructions executable by the processor and configured for:
enabling selection of a user interface (UI) window, the UI window comprising a UI element and an associated hover assistance element;
displaying the hover assistance element with the UI element within a viewable area of the UI window; and
persisting display of the hover assistance element.

8. The system of claim 7, wherein the hover assistance element further comprises a hover assistance value, the hover assistance value being displayed when the hover assistance element is persisted.

9. The system of claim 7, wherein
the UI window comprises a plurality of UI elements and a plurality of associated hover assistance elements; and further comprising
displaying the plurality of hover assistance elements simultaneously within a viewable area of the UI window; and
persisting the display of the plurality of hover assistance elements.

10. The system of claim 9, wherein predetermined visual attributes are applied to each of the plurality of hover assistance elements and each associated UI element, the predetermined visual attributes indicating an association between each of the plurality of hover assistance elements and an associated UI element.

11. The system of claim 9, wherein visual attributes are applied to each of the plurality of UI elements that do not have an associated hover assistance element.

12. The system of claim 3, wherein each of the plurality of hover assistance elements are operable to be selectively removed from persistent display and then selectively returned to persistent display, and, displaying a remaining plurality of hover assistance elements after a hover assistance element is removed.

13. A computer-usable medium embodying computer program code, the computer program code comprising computer executable instructions configured for:
enabling selection of a user interface (UI) window, the UI window comprising a UI element and an associated hover assistance element;
displaying the hover assistance element with the UI element within a viewable area of the UI window; and
persisting display of the hover assistance element.

14. The computer-usable medium of claim 13, wherein the hover assistance element further comprises a hover assistance value, the hover assistance value being displayed when the hover assistance element is persisted.

15. The computer-usable medium of claim 13, wherein
the UI window comprises a plurality of UI elements and a plurality of associated hover assistance elements; and further comprising
displaying the plurality of hover assistance elements simultaneously within a viewable area of the UI window; and
persisting the display of the plurality of hover assistance elements.

16. The computer-usable medium of claim 15, wherein predetermined visual attributes are applied to each of the plurality of hover assistance elements and each associated UI element, the predetermined visual attributes indicating an association between each of the plurality of hover assistance elements and an associated UI element.

17. The computer-usable medium of claim 15, wherein visual attributes are applied to each of the plurality of UI elements that do not have an associated hover assistance element.

18. The computer-usable medium of claim 15, wherein each of the plurality of hover assistance elements are operable to be selectively removed from persistent display and then selectively returned to persistent display, and, displaying a remaining plurality of hover assistance elements after a hover assistance element is removed.

19. The computer usable medium of claim 13, wherein the computer executable instructions are deployable to a client computer from a server at a remote location.

20. The computer usable medium of claim 13, wherein the computer executable instructions are provided by a service provider to a customer on an on-demand basis.
